(19) United States
(12) Patent Application Publication
(10) Pub. No.: US 2013/0050222 A1
(43) Pub. Date: Feb. 28, 2013

(54) KEYBOARD WITH EMBEDDED DISPLAY

(71) Applicants: DOV MORAN, Kfar Saba (IL); Uriel Roy Brison, Tel Aviv (IL)

(72) Inventors: DOV MORAN, Kfar Saba (IL); Uriel Roy Brison, Tel Aviv (IL)

(21) Appl. No.: 13/217,278

(22) Filed: Aug. 25, 2011

(51) Int. Cl. G06F 3/02; G06T 11/00; G09G 5/08

(52) U.S. Cl. 345/467; 345/168; 345/163

(57) ABSTRACT

A keyboard including an auxiliary display for use with a computer system that includes a processor, a primary display that displays active and non-active windows simultaneously, and a computer readable medium storing a computer program with computer program code, which, when read by the processor, allows a user to generate a command that captures a portion of text displayed in the active window and displays the captured text on the auxiliary display.

### FIELD OF THE INVENTION

The present invention relates to computer peripherals including computer keyboards and displays, and more particularly to a computer keyboard having an embedded display to simplify keyboard typing.

### BACKGROUND OF THE INVENTION

Interactions with computerized devices are generally achieved through the use of input devices. Input devices associated with computerized devices commonly include keyboards used for providing computer signals interpreted as characters. Most users, using such a regular keyboard, must repeatedly lift up their heads, re-focus their eyes on the computer screen and search for the current cursor position in order to see the text that has just been typed. In this manner, the user frequently refocuses his field of view (FoV) during typing, sometimes as often as every few seconds. The speed and accuracy of typing, for most users, is reduced considerably because they have to refocus their FoV from the screen to the keyboard and back.

Even with the rise in popularity of computer use, and though most people spend a large proportion of their time, at home or at work, using keyboards, very few people are full “touch typists” capable of keeping their FoV focused on the screen while continuously using a keyboard for character input. Some computer users can use keyboards and like input devices to type for a period of time without looking at the keyboard but must stop once in a while to re-orient their hands over the keyboard or look for a specific key on the keyboard, while shifting their eye focus.

There is therefore a need for a device and method to allow users of computerized devices such as keyboards to do away with part or most of such focus re-orientation pauses. Such a solution will increase typing speed, improve accuracy, and prevent eye strain.

### SUMMARY OF THE INVENTION

The present invention provides keyboards for computer systems that overcome the drawbacks of separating the input device (e.g., keyboard) from the display of the data entered. Keyboards of the present invention include small, embedded displays in close proximity to the keyboard keys that enable a user to see his input without shifting his focus away from the keyboard.

Aspects of the present invention relate to various embodiments of keyboards coupled with displays, including inter alia (i) keyboards that include small displays in the keyboard housing, and also include touch sensitive panels or additional keys for selecting options presented on the small keyboard display, (ii) password protected keyboards that prevent unauthorized access to an external device, such as a connected computer, (iii) keyboards that interface securely with a plurality of devices at once, and (iv) keyboards coupled with memory for backup of typed text.

Aspects of the present invention also relate to laptop computers that integrate a keyboard and small display into the keyboard portion of the laptop. This configuration enables exposing the keyboard and small display on an outer surface when the laptop is closed. In addition, the keyboard and the integrated small display are also useful when entering data and using the main laptop display: the small integrated display allows the user to stay focused on the keyboard during typing without having to glance at the main laptop display. The keyboard with the integrated small display is also useful when the laptop is connected to a docking station. The keyboard with the integrated small display is also useful as an accessory keyboard to a secondary laptop. The keyboard with the integrated small display is also useful as an accessory keyboard to e-books, iPads, web tablets and smartphones.

Keyboards that Include Small Displays and Additional Keys

In these embodiments of the present invention, an integrated small keyboard display is included in the keyboard housing. A user enters text by actuating the keyboard keys. According to embodiments of the invention, text entered in this manner appears on both the primary personal computer (PC) display and on the small keyboard display. The invention allows the user to remain focused on the keyboard without having to lift his gaze to the primary display in order to see the input. This feature is particularly useful for users of multilingual systems. In multilingual systems, a user typically switches between English and a local language. The user can switch the active language in several ways.

For example, in Microsoft Windows systems configured to support Hebrew, pressing both the alt and shift keys at the same time switches the active language. In these systems, when the active language is English, the user presses alt+shift and the active language is switched to Hebrew. Each key actuated on the keyboard now enters a Hebrew character instead of an English one. If the user presses alt+shift again, the active language is switched back to English. Each key actuated on the keyboard now enters an English character. Often, a user is mistaken as to which language is currently active. Thus, a user often enters a series of characters while looking only at the keyboard believing he is entering text in a first language, only to realize after looking up at the display that he has entered gibberish in a second language. By displaying the entered text within the user's field of view on the keyboard, the user will immediately notice the active language as he enters the text.

By contrast, in prior art systems, the user often discovers that he has entered gibberish only after a substantial amount of text has been entered, causing the user much aggravation.

According to further features in preferred embodiments of the invention, when a user selects text on the primary display (using, inter alia, keyboard or mouse operations) the selected text is displayed on the keyboard display. According to still further features in the preferred embodiments, text surrounding the selected text is also displayed on the keyboard display. Also, if the cursor is inserted within a text passage on the primary display (without selecting text), the keyboard display shows the cursor and the text surrounding the cursor. According to still further features in preferred embodiments, the keyboard display shows different information than that presented on the computer's primary display.

In accordance with an embodiment of the present invention, a computer system is taught, including a processor; a primary display connected to the processor, wherein the primary display can display multiple windows simultaneously, any of which can be selectively activated at any given time; a keyboard connected to the processor, wherein the keyboard includes input keys and an auxiliary display; and, a non-volatile computer readable medium storing a computer program with computer program code, which, when read by the processor, enables a user to generate a single command that identifies text displayed in the currently active window and automatically displays the identified text on the auxiliary display, and wherein the identified text is editable on both the primary and auxiliary displays simultaneously by the input keys. According to other embodiments, the identified text is editable on the auxiliary display and subsequently uploaded to the primary display. The identifying of text displayed in the currently active window is called a text capture operation in the current specification.

According to preferred embodiments of the invention, the user initiates the command by performing a mouse click, a combination key-press and mouse click, a mouse-hover operation, or a caret (text insertion point indicator also known as text cursor) position change. Any of these activities are collectively referred to as mouse or caret operations. The user can then edit the identified text by typing on the keyboard.

According to further features in preferred embodiments of the invention, the input keys are grouped into left and right groups of keys and the auxiliary display is situated between the two groups, as depicted in FIGS. 4, 15A and 15B.

According to alternative preferred embodiments of the invention, the input keys are grouped into at least one upper row of keys and at least one lower row of keys and the auxiliary display is situated between these upper and lower rows as depicted in FIGS. 3 and 14.

Further in accordance with an embodiment of the present invention, the text capture operation includes calls to operating system functions. In particular, the operating system functions include commands to (i) access an operating system object associated with a mouse pointer position or caret position on the primary display, and (ii) return a value of the object. Alternatively, the keyboard driver software includes a substitute screen render function that provides a text value to the auxiliary display. This substitute screen render function can either replace (“override”) the operating system screen render function, or the substitute screen render function can partially replace (“augment”) the operating system screen render function. The latter is accomplished by having the substitute screen render function call the operating system screen render function.

Certain operating system (OS) functions provide screen coordinates of an active or indicated text window and of the mouse pointer or of the caret position. According to certain embodiments of the invention, the processor calls these OS functions that return the text window coordinates and mouse pointer or caret coordinates. Using these coordinates, the processor then calculates an overlap between the text in the active or indicated window and the mouse pointer or caret and extracts text contained in the overlap. The processor sends this extracted text to the auxiliary display. In certain embodiments, part of this overlap calculation includes considering the font size employed in rendering the text on the primary display.

Alternatively, the processor calls operating system functions that provide a bitmap of an active or indicated window in the primary display, and the processor performs character recognition methods (such as those employed in optical character recognition (OCR) systems) on the bitmap in order to extract the text data. The processor also calls operating system functions that provide screen coordinates of the mouse pointer or of the caret position. Based on the mouse pointer or caret coordinates the processor divides the screen bitmap into two bitmaps: left of the cursor and right of the cursor. The processor then displays the text entry point on the auxiliary display between the texts extracted from these two bitmaps.

In accordance with an embodiment of the present invention, a computer system is taught, including:

a processor;

a primary display for displaying a first text or graphic, wherein the primary display can display multiple windows simultaneously, any of which can be selectively activated at any given time;

a keyboard connected to the processor, the keyboard including input keys and a dynamic secondary display for displaying a second text or graphic different than the first text or graphic; and,

a non-volatile computer readable medium storing a computer program with computer program code, which, when read by the processor, selectively displays either the first text or graphic on the primary display or the second text or graphic or the secondary display in response to input from the input keys.

In some cases, multiple key presses are required in order to generate an on-screen character. For example, both Chinese Pinyin and stroke characters typically require a user to enter multiple keystrokes in order to generate a single Chinese character. According to the teachings of the present invention, as the user actuates a series of key presses, a list of possible multi-stroke characters is presented on the secondary display. This is the second text or graphic. As the user actuates more keys, there are fewer possible multi-stroke characters that include the actuated key combination. It is useful for the user to see which characters he is generating as he presses keys.

Moreover, when the keyboard display is touch-sensitive, the user can select one of the character options by touching it on the secondary display. This saves the user the effort of having to complete the entire sequence of key presses in order to generate a desired multi-stroke character. When the user selects one multi-stroke character from among those displayed in the second text or graphic, the selected character is sent to the primary display. This is the first text or graphic.

According to further features in preferred embodiments of the invention, the input keys are grouped into left and right groups of keys and the keyboard display is situated between the two groups, as depicted in FIGS. 4, 15A and 15B.

In certain embodiments of the present invention, a keyboard includes a plurality of input keys and a keyboard display. The keyboard is configured for connection to at least one computer having a respective primary display. When a cursor on the primary display is inserted into a text passage, the keyboard display displays the text passage.

### Password Protected Keyboards

In these embodiments of the present invention, the keyboard contains a processor that runs a user-authentication routine and a memory for storing the user-authentication routine and password data. Communication between the keyboard and any connected device is blocked until the routine authenticates the current user. For example, when the keyboard of the present invention is connected to a computer, the keyboard monitor prompts the user to enter a user id and password. This prompt is not displayed on the primary computer display. When the user enters a user id and password, the input is only displayed on the keyboard display; it is not displayed on the primary display. Until the user is authenticated by entering a valid user id-password combination, the keyboard does not transfer any key depression information to the computer.

Another application is to store multiple passwords on the keyboard memory for a plurality of websites and applications. The user can retrieve the various passwords from the keyboard memory by entering a master password to the keyboard. This function is similar to “password keeper” applications that aid users who have multiple passwords. The main advantage of storing the password list on the keyboard memory rather than on the PC is the high degree of security attributed to information stored on a peripheral device (and not on the PC) which is harder for an unauthorized user to access.

According to certain embodiments of the present invention, a keyboard is adapted for connection to at least one computer having a dynamic primary display for displaying a first text or graphic, the keyboard comprising:

a keyboard processor;

a dynamic secondary display connected to the keyboard processor for displaying a second text or graphic different than the first text or graphic;

a plurality of input keys connected to the keyboard processor; and,

a computer readable medium storing a computer program with computer program code, which, when read by the keyboard processor, selectively displays either the first text or graphic on the primary display or the second text or graphic on the secondary display in response to input from said input keys.

According to further features of preferred embodiments of the invention, the second text or graphic is a user password, and the keyboard processor blocks communication with the at least one computer pending verification of the user password. The first text or graphic is data entered after the password has been verified.

### Keyboards for Multilingual Systems

According to some embodiments, the keyboard includes a graphic button that presents an icon representing the current active language. In some embodiments, a physical button is provided on the keyboard for (i) displaying the current language, and (ii) for the user to change the language. The button has a dynamically modifiable surface for presenting an icon of a currently active input language. Such icons include, inter alia, a flag of a country where the language is spoken. When this button is actuated, the input language is changed and a new icon is presented on the button. According to a preferred embodiment, the button surface presenting these icons is an e-Ink display.

In other embodiments, the button is not a physical button; rather, a virtual button is presented as an icon on a touch screen. For example, when the embedded keyboard display is a touch screen, or, at least a portion of the display is touch sensitive, the language icon is displayed at a touch sensitive location on the embedded keyboard display and is actuated by a user touch at that location.

Keyboards that Interface to Multiple Devices

In these embodiments of the present invention, the keyboard connects to multiple devices simultaneously. For example, the keyboard connects to a personal computer and to a mobile phone simultaneously. The keyboard includes at least one button (virtual or physical) for (i) displaying the current active device, and (ii) for the user to change the active device. An icon representing the type of device (pc, phone, stereo, etc.) displayed on the virtual or physical button indicates the current active device. Alternatively, the different devices are assigned names (e.g., Phone, or Device1) and the name is displayed on the button. One advantage of connecting mobile devices to the keyboard via USB is the opportunity to charge the mobile device battery over USB connection.

According to further features of preferred embodiments of the invention, the keyboard is adapted for connection to at least one computer and to at least one handheld electronic device simultaneously, for example through a plurality of USB connectors or over Wifi or Bluetooth connections. In these embodiments, the second text or graphic identifies one of the connected devices to receive input from the keyboard. The first text or graphic is data entered through the keyboard to the primary display of the active connected device. The term handheld electronic device includes, inter alia, mobile phones, MP3 players, eBook readers, iPads and web tablets. The at least one computer includes, inter alia, desktop and laptop computers.

Keyboards with On-Board Memory

In these embodiments of the present invention, the keyboard includes an embedded processor and memory. The primary functions of the embedded processor and memory are to provide password authentication (described above), and character prediction. For example, a character prediction routine runs on the embedded keyboard processor and presents possible words or phrase completion as the user enters text. These options are presented only on the keyboard display, not on the main display. By offloading text prediction to the keyboard processor, the main computer is freed from having to allocate computing resources to text prediction. In addition, the embedded processor and memory can also store recently entered text and serve as a backup in case the main computer crashes. Further, the embedded memory can also be configured to be available as additional memory for use by a connected external computer or handheld device.

### Laptops Having Keyboards on an Outer Surface

In these embodiments of the present invention, a laptop computer having a swivel hinge is provided. The hinge connects two sections of the laptop that open in clamshell fashion. A first section contains the laptop's primary screen and a second section contains the laptop keyboard and a small, secondary screen. When a user opens the laptop in clamshell mode, the keyboard and primary display are open for use. This is the conventional mode of operation for a laptop computer.

An alternative mode of operation, according to the teachings of the present invention, places the keyboard on the outer surface of the closed laptop. In this mode the user types on the keyboard and views his input on the secondary screen. The primary display is not used in this mode. The user sets up the laptop in this alternative mode with the aid of the swivel hinge. After opening the laptop in clamshell mode, the user rotates the keyboard section around the swivel hinge and then close the clamshell, placing the keyboard on the outer surface of the closed laptop. Alternatively, after opening the laptop in clamshell mode the user rotates the laptop display so that the display faces away from the keyboard and then closes the laptop by bringing the display under the keyboard. The result in both cases is that the keyboard is exposed and the primary display is covered.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosed subject matter and do not limit the scope of the invention. In the drawings:

FIG. 1 shows a side view of a computerized environment in which the disclosed subject matter is used, in accordance with some exemplary embodiments of the invention;

FIG. 2 shows a front view of a computerized environment in which the disclosed subject matter is used, in accordance with some exemplary embodiments of the invention;

FIG. 3 shows an input device, in accordance with some exemplary embodiments of the invention;

FIG. 4 shows an input device, in accordance with some exemplary embodiments of the invention;

FIGS. 5-9, 11 and 13 are flow diagrams of methods for capturing text from a primary display and presenting the captured text on an auxiliary display, in accordance with some exemplary embodiments of the invention;

FIG. 10 shows an active window within a primary display (not shown);

FIG. 12 shows an active window within a primary display (not shown) divided into left and right portions based on the position of a cursor;

FIG. 14 shows an input device, in accordance with some exemplary embodiments of the invention, connected to a personal computer and a mobile phone;

FIGS. 15A and 15B show an input device, in accordance with some exemplary embodiments of the invention, connected to a personal computer; and

FIGS. 16A-D show a laptop computer that includes a keyboard and embedded secondary display, in accordance with some exemplary embodiments of the invention.

### DETAILED DESCRIPTION OF THE PREFERRED EMBODIMENTS

The present invention is described below with reference to flowchart illustrations and/or block diagrams of methods, apparatus (systems) and computer program products according to embodiments of the subject matter.

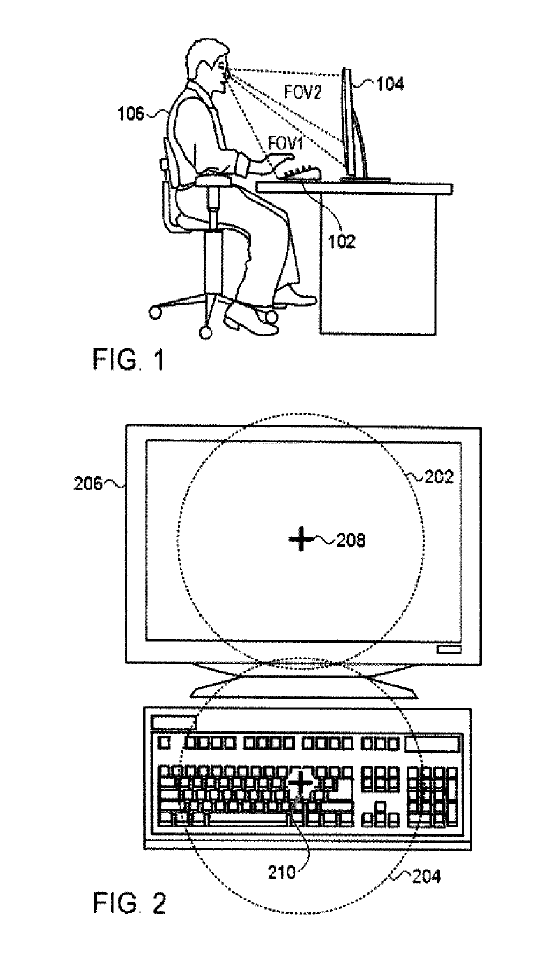

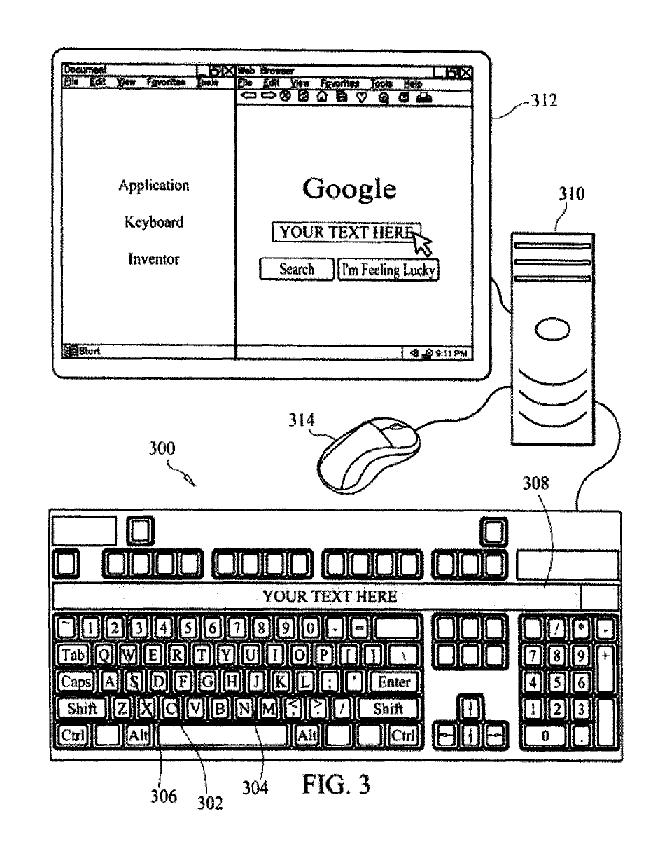

One technical problem dealt with by the disclosed subject matter is that in prior art systems, users are required to shift their FoV from an output device to an input device. This problem is illustrated in FIGS. 1-2.

Reference is now made to FIG. 1 showing a side view of a computer environment in which the disclosed subject matter is used, in accordance with some exemplary embodiments of the subject matter. Referring to FIG. 1, keyboard 102 and screen 104 are both connected to a computer (not shown). When keys on keyboard 102 are actuated, a corresponding one or more character is displayed on screen 104. Keyboard 102 is located in FoV1 outside the FoV2 in which screen 104 is located, requiring user 106 to shift his gaze between keyboard 102 and screen 104. The distances of keyboard 102 and screen 104 from the user's eyes are different, and therefore a change of eye focus is required when shifting from FoV1 to FoV2 and back.

Reference is now made to FIG. 2 showing the Fields of View in a prior art computer environment from a user perspective. FIG. 2 shows FoV1 and FoV2 of FIG. 1 as circular FoVs 204 and 202, respectively. A user using the computer environment of FIG. 2 looking at screen 206 will generally have FoV 202 and focal point 208. During typing a typical user will shift from FoV 202 to FoV 204 and focus on focal point 210. The distance from the user's eyes (not shown) to focal points 208 and 210 is not equal, requiring a change of focus every time the user shifts from FoV 202 to FoV 204. It is clear from FIGS. 1 and 2 that users of prior art computer environments switch between different, non-overlapping FoVs while typing.

The present invention teaches an input device and method for use thereof with computerized devices that reduces the need to shift a user's FoV. Another technical issue dealt with by the disclosed subject matter is how to increase the speed and accuracy of using an input device, such as a keyboard, connected to an output device, such as a screen display.

One technical solution is to provide an output screen display in the same FoV as the input keys.

Yet another technical solution is to determine the location of the user's fingers and/or to determine which keys the user is likely to use next, based on various indications received from the input device, and to display this location on an output device connected to the input device, such as a screen display.

One technical effect of utilizing the present invention is reducing the need for the user of a computerized device to shift his FoV or refocus his eyesight between an input device such as a keyboard and an output device such as a screen. Another technical effect of utilizing the present invention is achieving a new type of keyboard with an enhanced level of typing efficiency and user friendliness.

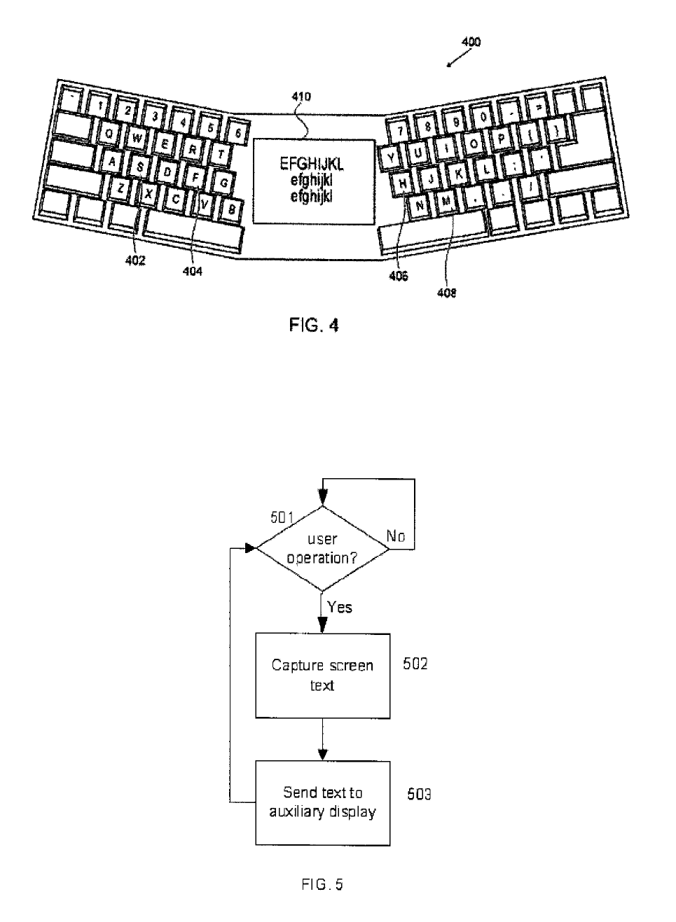

Reference is now made to FIG. 3 showing an input device in accordance with the present invention. Input device 300 is preferably a keyboard that can be used by any number of devices, including PCs, televisions, terminals, web tablets, eBooks, mobile phones, and the like. Typically, input device 300 is used in association with a PC or television. Input device 300 comprises various keys 302, 304, 306 and display 308 on the input device itself. Display 308 can be a text-only display or a graphical display. By placing display 308 on keyboard 300 within the same for FoV as the input keys, the user can see each character as it is being typed.

A computer program such as driver software runs on a processor connected to the input keys and to display 308. This program displays text and graphics associated with the actuated input keys on display 308. The driver software is executed upon connection of the keyboard device to a power source. The driver software can either be stored in an on-board memory (not shown) in input device 300 or installed by the user from a CD or other storage media or downloaded from the internet. According to certain embodiments of the invention, the processor is located in the connected personal computer or television. According to other embodiments of the invention, the processor is located in input device 300. In addition to displaying input information on display 308, the computer program further controls communication between the input device and external connected devices such as a PC or television.

According to preferred embodiments of the invention, the program that runs on the processor configures input text for display 308. For example, the font size of typed characters or words is adjusted by the program that runs on the processor in order to fit into display 308. Text just entered is also adjusted or modified in order to draw the user's eye to the newly entered text. This is done, inter alia, by increasing the font size, changing the font color, highlighting the background, or underlining. Moreover, according to preferred embodiments, display 308 is slightly raised so that it faces the user or is angled toward the user.

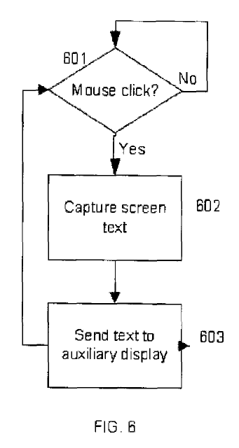

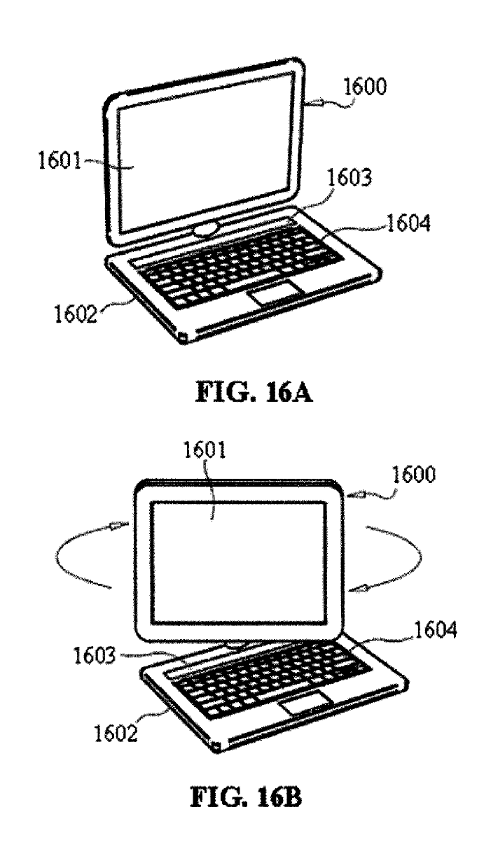

Reference is now made to FIG. 4 showing an alternative embodiment of the input device of the subject matter. Input device 400 comprises a keyboard having a screen display 410 in the center of the input device. Input device keys (e.g., keys 402, 404, 406, 408) are arranged on both sides of screen display 410. This particular layout may be more convenient for Asian language input devices and thus may be used in keyboards for Chinese, Japanese and other languages that include multi-stroke characters. This is further described with respect to FIGS. 15A-B herein.

In some embodiments of the subject matter the input device further comprises a feature to allow spell checking and predictive text input, to be presented on the keyboard display.

Computer systems according the teachings of the present invention include: a processor connected to a primary display that displays active and non-active windows simultaneously; a keyboard connected to the processor, wherein the keyboard includes input keys and an auxiliary display; and, a computer readable medium storing a computer program with computer program code, which, when read by the processor, enables a user to generate a single command that captures a portion of text displayed in an active window and displays the captured text on the auxiliary display. The captured text is then editable by the keyboard keys.

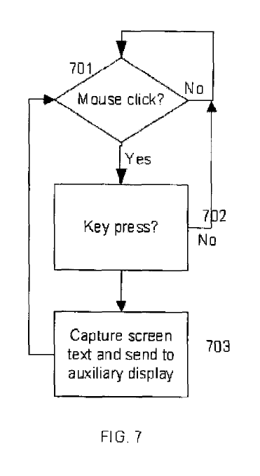

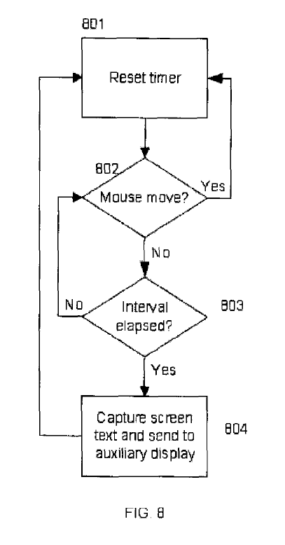

In some cases the user wishes to edit or view text from the primary computer display on the embedded keyboard display (in contrast to viewing text as it is being typed). Reference is now made to FIG. 5 showing a flow diagram of the basic method of capturing text in the vicinity of a cursor on a primary display, for display on an auxiliary display. At step 501, the computer checks if a user command to capture text has been issued. In certain embodiments, the user command writes to an address and the check is done by the computer polling that address. In other embodiments, the user command initiates an interrupt routine. The program loops over step 501 until a command is detected. When a command is detected, the computer (i) captures text from primary display 206 (step 502) in the vicinity of the cursor; and (ii) displays the captured text on auxiliary display 308 or 410 (step 503). There are several different ways a user can initiate a command to capture text. Four methods are illustrated in FIGS. 6-9. Any or all of these methods can be used in a system. In some embodiments, the user enables one or more of these methods.

Reference is now made to FIG. 6 showing a flow diagram of a first method of initiating a command to capture text for display on the auxiliary display based on a mouse click. At step 601 the computer waits for a mouse click. When a mouse click is detected, the computer (i) captures text from primary display 206 (step 602) in the vicinity of the mouse click; and (ii) displays the captured text on auxiliary display 308 or 410 (step 603).

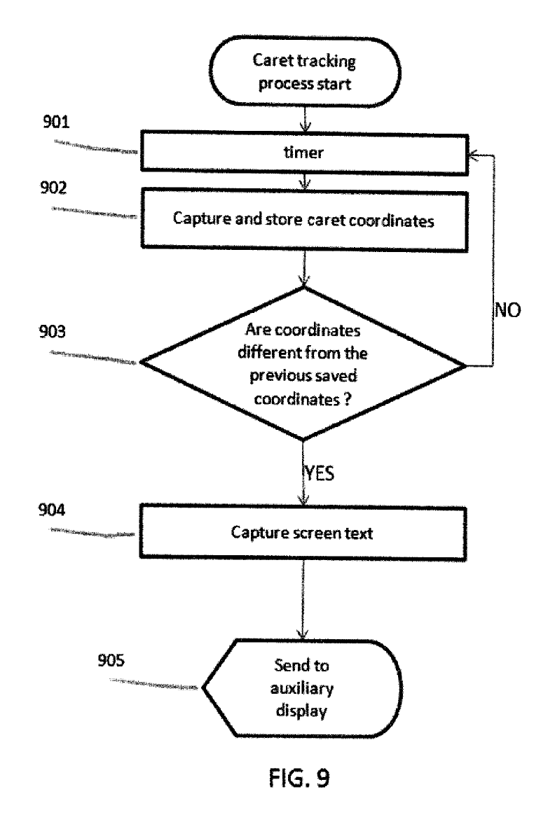

Reference is now made to FIG. 7 showing a flow diagram of a second method of initiating a command to capture text for display on the auxiliary display based on a combination of a mouse click and a keyboard press. Typically, the keyboard press is a specific key, inter alia, the alt, ctrl or shift key. In certain embodiments, the keyboard press is a specific key combination, executed either simultaneously or serially, including inter alia, the alt, ctrl or shift key and a letter or number key. At step 701 the computer waits for the mouse click-key press combination. When a mouse click-key press combination is detected (step 702), the computer (i) captures text from primary display 206 in the vicinity of the mouse click; and (ii) displays the captured text on auxiliary display 308 or 410 (step 703).

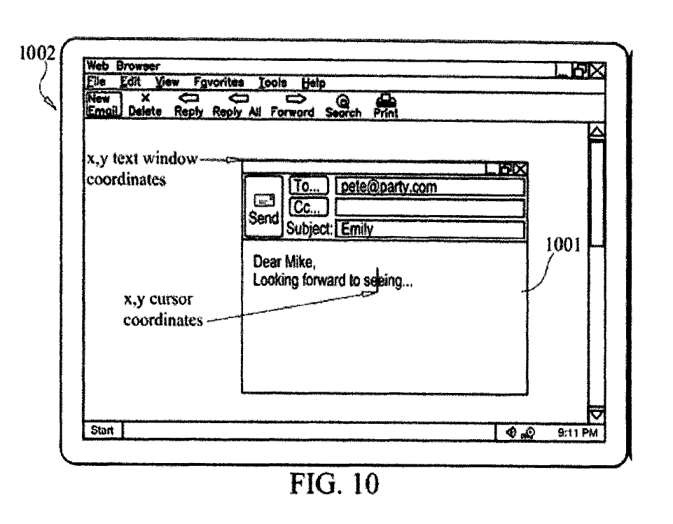

Reference is now made to FIG. 8 showing a flow diagram of a third method of initiating a command to capture text for display on the auxiliary display based on a mouse hover operation. A mouse hover operation means the mouse pointer is moved to a screen location and remains at the location for a period of time. According to a preferred embodiment, the mouse-hover operation requires that the mouse pointer move during the hover time period, and that the cursor remain within close proximity to a single location throughout the hover time period. This ensures that the hover is a deliberate user operation and that the user has not simply let go of the mouse. According to another embodiment, a touch pad or touch screen is used to control the mouse pointer. In these cases a mouse hover operation requires that the touch pad or touch screen detect user touch throughout the hover time period. This too, ensures that the hover is a deliberate user operation and that the user has not simply removed his finger from the touch pad or touch screen.

At step 801 the computer resets the hover operation timer and begins measuring the duration of the mouse pointer at its current position. If the mouse is moved from its current position (step 802) the timer is reset. According to preferred embodiments, step 802 resets the timer only when movement is detected beyond a given distance from the original pointer position indicating that the user deliberately moved the mouse. When a mouse hover operation has lasted the required time period (step 803), the computer (i) captures text from primary display 206 in the vicinity of the hovering mouse pointer; and (ii) displays the captured text on auxiliary display 308 or 410 (step 804).

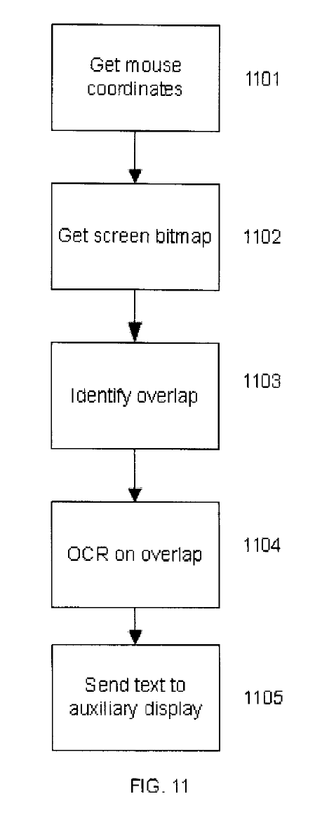

Reference is now made to FIG. 9 showing a flow diagram of a fourth method of initiating a command to capture text for display on the auxiliary display based on caret focus change operation. A caret focus change means that the caret (text insertion point) has changed its location, meaning either its X coordinate, either its Y coordinates or both coordinates. According to a preferred embodiment, a timer will trigger a check on the caret focus change after a predetermined reasonable interval. The interval should be smaller than an average user input delay using his keyboard or his mouse (step 901). When the timer is set off, it will trigger an operation of acquiring the caret current position coordinates and storing them (step 902). These data coordinates can be retrieved, for example on a Windows OS, by utilizing the GetGUIThreadInfo API (Application Programming Interface). These data should be stored for the following caret checking operations.

When a followed operation is triggered, a check will be made to see if the new caret coordinates are different from those which were last stored. If this is the case, than the process will proceed to the next step (904). At this step the text capturing operation will occur and its output will be displayed on the keyboard screen (step 905). If not, the control will be given to the timer in order to launch the next caret checking operation.

In addition to the described process, one can determine the sensitivity of the process. This is related to the fact that the text capturing will be launched only if a predetermined threshold is exceeded. For instance, text capturing occurs only if the caret is moved on the Y coordinates, or only if the caret is moved by a predefined gap.

The present invention teaches several methods for capturing text within a screen that presents a plurality of open application windows. According to one method, an initialization step includes the setting of a monitor for the mouse and keyboard inputs. On the Windows Operating System (Windows OS), for example, a SetWindowsHookEx API can be used to define a monitor for the mouse and keyboard inputs. This API enables monitoring messages sent from a mouse and from a keyboard to the operating system and therefore enables obtaining screen coordinates and data involved in these operations. Using the SetWindowsHookEx API to install hook procedures for a mouse (WH_MOUSE) and for a keyboard (WH_KEYBOARD), enables monitoring and intercepting inputs from those devices.

On mouse message interception, a procedure begins for identifying the user action. With reference to FIG. 8, if the user enabled a mouse-hover operation as a trigger for text capture, the mouse message is checked to see if it indicates that the mouse was moved (e.g. WM_MOUSEMOVE message). If the mouse was moved, the process resets the hover timer (step 801). If the timer exceeds the defined hover time threshold (step 803) (i.e., no WM_MOUSEMOVE message was intercepted) a text capture operation is invoked (step 804) and the timer is reset (step 801).

If the mouse message is not a move message or if the hover option is not enabled, then the mouse message is checked to see if it is a click message (e.g WM_LBUTTONDOWN). If it is not, the process waits for the next mouse input. If a click message was received, a check is made to see if the user defined a mouse click and key depression combination action as a command trigger. If a mouse click and key depression combination action are defined as a command trigger, the process checks if the user is depressing the predefined key. On windows OS the GetKeyState API can be used for this purpose. If the user is depressing the predefined key, the process invokes the text capture operation. If the user is not depressing the predefined key, the process goes back and waits for the next mouse input. If the mouse click and key press combination is not defined as a command trigger, and the mouse click alone is defined as a command trigger, the process proceeds to text capture on a mouse click.

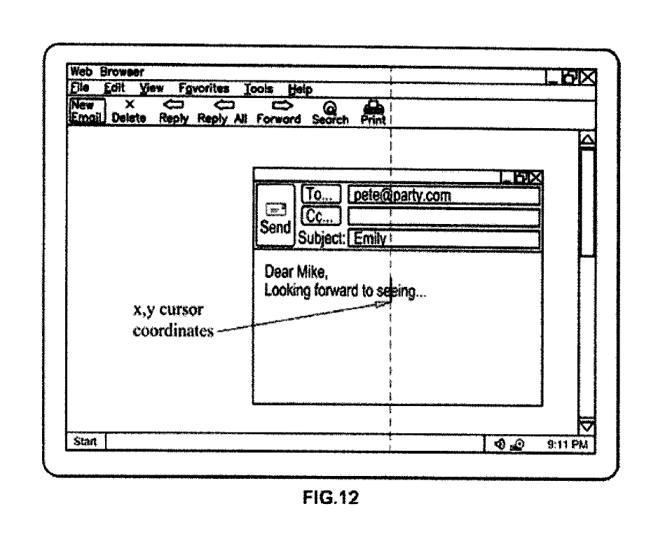

When a text capture operation is triggered, the present text cursor coordinates need to be identified in order to retrieve the text under and around the cursor location. These coordinates can be retrieved inter alia using the GetCursorPos API in Windows OS. An alternative method for that is capturing the caret coordinates using GetCaretPos or GetGUIThreadInfo APIs. The text cursor coordinates are passed on to the text capturing operation which retrieves the text in the vicinity of these coordinates. Reference is made to FIG. 10 showing an email window 1001 containing text, within primary display 1002. Window 1001 coordinates within the primary display are indicated in FIG. 10, as are the cursor coordinates.

Several methods are presented for capturing text from a screen. The purpose of these methods is to capture a line or an area of text in the vicinity of a cursor or mouse pointer. In order to elevate the reliability of the process, when a method fails, it is followed by a different method. The methods employed in a given system and their order are defined based on the target platform specifications and the target platform OS.

The text capture methods can be generally divided into two categories: OS specific methods and non-OS specific methods. The OS specific methods include methods that utilize the OS instrumentation, and therefore are more OS specific; the non-OS specific methods include methods which are less OS specific and make less use of the OS instrumentation. Another method for achieving the goal of text capturing, is a method that, in fact, constitutes a category of its own. In this category the method of capturing is unaware or indifferent to the text that it is supposed to capture, but nonetheless its result will be the user focused text. Methods in this category will capture or grab a portion of the screen image that contains the desired text, hence will achieve the purpose which is the text capturing. This is the text agnostic methods category.

The following are examples of OS specific methods. The examples are presented in the context of Windows OS, but can be implemented in other operating systems using similar functions from the target OS.

### Example 1

A message of the type WM_GETTEXT or EM_STREAMOUT is sent to the window component (control) to which the mouse pointer points. Sending these kinds of messages to the window components, provided that they are of the “edit” class type, sends the text in those controls to the message sender.

### Example 2

Another method on Windows OS is to use the Microsoft Active Accessibility (MSAA) API or the Microsoft UI Automation (WA) API. These APIs are designed to help Assistive Technology products interact with standard and custom UI elements of an application, i.e., to access, identify, and manipulate an application's UI elements. Therefore these APIs can be used to retrieve text from a window component. In order to retrieve an accessible object from a window component that is currently being pointed at by the mouse pointer, the user calls the AccessibleObjectFromPoint API. An accessible object is an object that implements the IAccessible interface, which exposes methods and properties that make a UI element and its children accessible to client applications. After retrieving the object, one can retrieve the text of the UI component by using the IAccessible methods get_accName and get_accValue.

### Example 3

This method involves the use of hooking schemes on Windows OS. In this case, hooking is used to intercept the APIs that are used in the process of outputting text to a screen such as TextOut, ExtTextOut etc. The objective of the hooking method is to create a user-defined substitute procedure having a signature similar to a targeted API procedure. Every time the targeted API procedure is called by the system, the user-defined substitute procedure is called instead. Hooking gives the user-defined substitute procedure the ability to monitor calls to the API procedure. After the user-defined substitute procedure is called, control is transferred back to the API procedure in order to proceed with its original task.

In Windows OS, there are several techniques which can be utilized in order to hook the APIs of interest which are called by the target process. One of those techniques is called IAT (Import Address Table) hooking. When a process use a function in another binary (i.e. DLL), it must import the address of that function (in our case, import the address of the ExtTextOut API from the GDI32 DLL). Ordinarily, when using Windows OS APIs, the process will use a table called IAT in order to save this address. This gives a chance for the hooking procedure code to overwrite the address of the API of interest with the user-defined substitute procedure address. In order to do so the hooking procedure code should reside in the address space of the target process. For that reason, usually, the hooking procedure code resides in a DLL and is injected to the target process address space using Windows hooks (setWindowHookEx) or using CreateRemoteThread and LoadLibrary API in conjunction.

After the hooking procedure is injected to the target process, each time a call is made from this process to a hooked API the hooking procedure is called instead. Thus, the user-defined hooking procedure obtains the data of interest and then calls the original API function. When monitoring the text output APIs the hooking procedures for those APIs are injected into the process running the window component of interest. This is the window in which the mouse pointer located.

After injecting the hooking procedures (DLL) to the targeted process, the window component is forced to be redrawn in order for the text output APIs to be called and monitored. In order to do so, the windows WM_PAINT message is sent to the window component of interest, or the RedrawWindow API is used to redraw the rectangle in the window that corresponds to the mouse pointer location. Another alternative for that is to use the InvalidateRect and the UpdateWindow APIs in conjunction. When the window is redrawn, the hooking procedures can spot the calls to the text output APIs, and retrieve the text that is written to the window area as well as the window coordinates written to. Comparing these coordinates to the mouse pointer or caret coordinates provides the text that is under the mouse pointer or around the caret, respectively. According to some embodiments, this step includes mapping the mouse pointer or caret coordinates onto the window text coordinates.

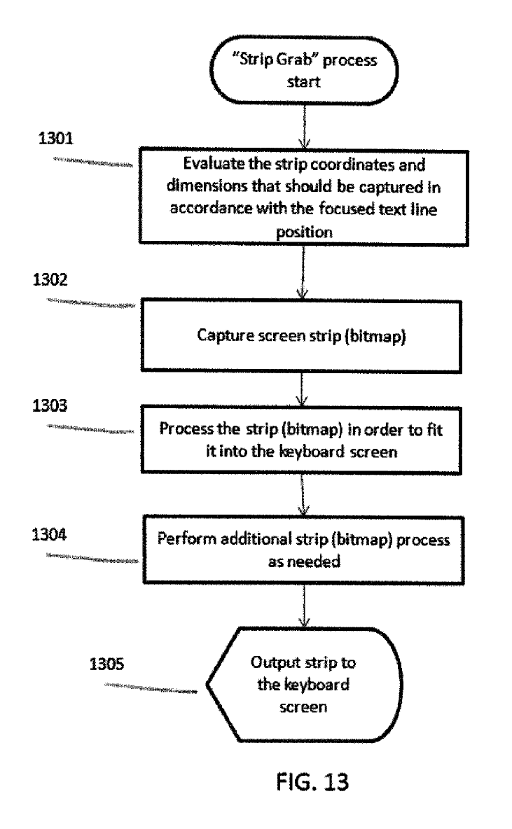

Non OS-specific text capturing methods make a use of character recognition techniques similar to those employed in Optical Character Recognition (OCR) systems. Text capturing methods of this category retrieve a bitmap image of the screen area under the mouse pointer or text cursor and perform character recognition techniques to obtain the desired text. These methods are illustrated in FIG. 11.

Referring to FIG. 11, mouse or caret coordinates are retrieved in step 1101 and a bitmap of the screen area is obtained in step 1102. In step 1103, these two sets of coordinates are compared and mapped onto a single space in order to extract a relevant section of the screen bitmap. In step 1104, character recognition techniques are applied to the selected bitmap area and the result is sent to the auxiliary display in step 1105. In step 1104, character recognition techniques are referred to as OCR.

Once a method has yielded the desired text, the text is formatted and adjusted to fit the requirements of keyboard display 308 or 410. This step includes, inter alia, resizing the length of the text to fit the maximum length of text that can be displayed on the keyboard display. One other task to be performed is to determine the location of the text cursor within the text displayed on the keyboard display. The term “text cursor” refers to the text insertion point (a.k.a. caret) indicated by, inter alia, a blinking vertical bar in systems running Windows OS.

OS-specific text capture methods compare the text cursor coordinates and the captured text area coordinates and text size, to determine which character is the closest to the text cursor and hence to the text insertion point. According to preferred embodiments, this process uses font related OS APIs in order to determine the font metrics in the text rectangle, and computes the character closest to the text cursor based on these metrics. Relevant APIs for this step, on windows OS, can be APIs such as GetCharABCWidthsFloat, GetCharABCWidths etc.

Non OS-specific text capture methods perform character recognition in two steps: (1) recognizing the text left of the text cursor; and (2) recognizing the text right of the text cursor. The text cursor position is between the left and right texts.

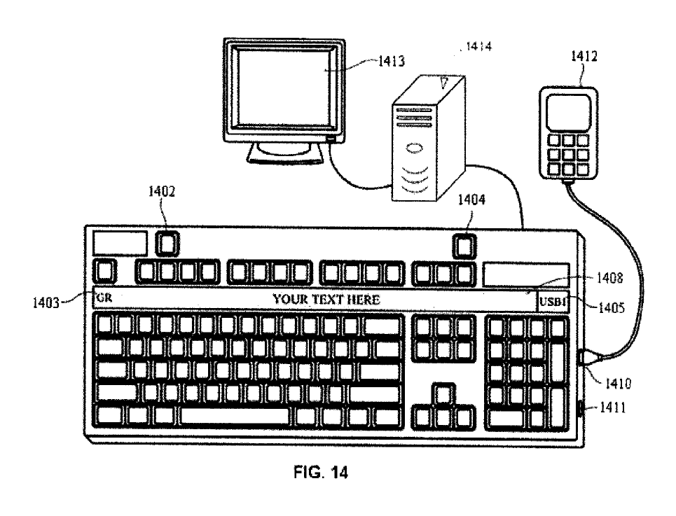

This last method is now described with reference to FIG. 12. According to this method, the bitmap is divided into two halves according to the location of the text cursor: a bitmap left of the cursor and a bitmap right of the cursor, as illustrated in FIG. 12. Character recognition methods are applied to each half separately. In order to display relevant text on the auxiliary display, text from the right border of the left image is concatenated with text from the left border of the right image. The concatenated text is sent to the auxiliary display, with the cursor inserted between these two text parts.

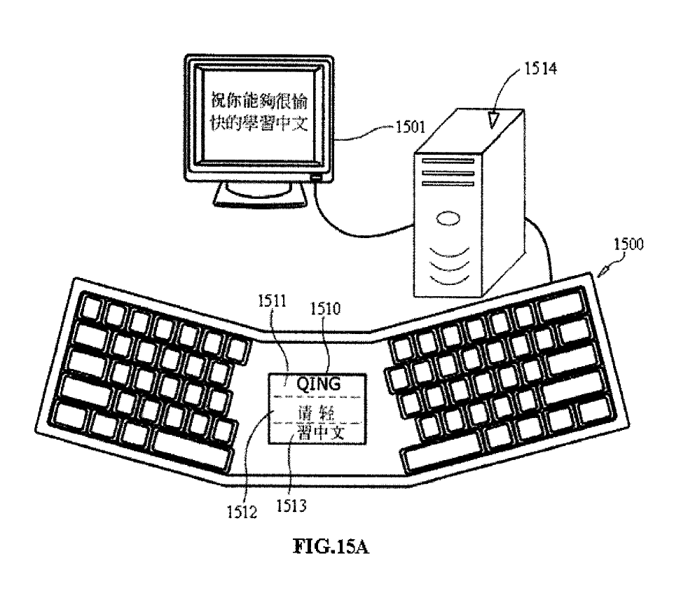

Text agnostic methods will make use of a screen image capturing technique and some other image processing methods and techniques. Those methods will be used in order to capture a portion of the screen image that contains the text, which the user has his focus on. In addition, the captured image portion will be processed in order to meet the demands of the auxiliary keyboard screen. For example, it will be scaled in accordance with the keyboard screen dimensions before rendering it on this screen. An example embodiment for such method, as referenced in FIG. 13, is the “Strip Grab” method. The image portion containing the text will be referred to as a strip.

In step 1301 an evaluation process of the strip coordinates and dimension will be done. In general, the strip should contain the text line that is under the user's focus, which means the text pointed out by the cursor or the line of text which is referenced by the caret. The coordinates of the cursor or the caret will be preferably regarded as the midpoint of the strip. These coordinates can be retrieved, for example, on windows OS by utilizing some APIs such as the GetCaretPos API or the GetGUIThreadInfo API. By using those APIs, one can retrieve information about the caret and in particular its location on the screen.

In addition to that information, the width and height of the strip should be obtained also in order to capture it. The width of the strip, for example, again in windows OS, can be obtained by the width of the window client area that the text or the strip resides in. This can be done by invoking the API GetWindowRect or GetClientRect after finding the relevant window by using WindowFromPoint API. GetClientRect, will retrieve a rectangle structure that represent the window client area size. From that information one will learn the width of the window which in turn represents the width of the strip. Since the height of the strip should be about the height of the caret (since the text font is about the size of the caret or smaller), one can obtain this height using the already mentioned API GetGUIThreadInfo. This API will retrieve a structure called GUITHREADINFO. This structure contains information about the caret.

The relevant information is the caret height that is obtained from a rectangle structure dimension set in GUITHREADINFO structure. This rectangle structure represent a rectangle that bounds the caret, hence, the caret height will be the difference from the rectangle bottom to its top. With this information on hand, one can proceed to the next step of the process marked as step 1302. On the other hand if no caret is present and this information could not be obtained, one can conclude the there is no editable text in the region and should decide either to end the process now, or to proceed with predetermined strip image.

In step 1302 the strip capturing or grabbing process will begin. In this step the screen image portion will be captured with the specific dimensions and location that were obtained in the previous steps. One who use the Windows OS can utilize the Gdi32 API capabilities for the mission. Applying the Bitmap API of the GDI32 as BitBlt or StretchBlt, for example, can provide a screen capture with the appropriate strip dimension and location. This could be done after retrieving the handle of the display device context using the API GetDC. Once the screen strip is retrieved as a bitmap the process moves forward to step 1303. In this step the strip should be scaled in order to fit in the keyboard screen dimension. This could be done already in the previous step using the mentioned APIs as the StretchBlt or by other preferable image processing API. This will lead to a final optional step, where additional image processing, such as transformation to gray scale, will be performed in accordance with the keyboard screen displaying capabilities. Now the strip can be sent as output to the keyboard screen (step 1305) in order to complete the process.

The types of methods used and their sequence is determined by the type of driver that was installed on the system. Each OS (and possibly each OS version or different distribution package) may have a different driver. During keyboard installation the appropriate driver for the specific OS configuration is selected and installed.

Finally, if all attempts and methods fail to deliver the text, then a predefined text or a predefined image is output to the small keyboard display, such as an empty line of text or the message, “error reading screen text.”

In some embodiments of the present invention, a more secure password entry is provided in combination with the input device. Input devices such as legacy keyboards comprise an internal processing device for managing the interpretation of physical input through typing and the sending of signals to the associated computerized device. Such legacy systems are difficult to hack.

In accordance with some embodiments of the present invention, a password or other information retention computer program is provided on the keyboard device. When a user is required to enter a password, the user enters the password on the keyboard device, wherein the entry is visible on the keyboard screen but not on the computer device. When the user enters his password, the keyboard sends a confirmation to the computer through the legacy keyboard connection. However, the password text is not transferred to the computer. Thus, it is more difficult for third parties to obtain access to the password. The keyboard may therefore enable encrypted password storage.

In other words, a plurality of different user passwords for a plurality of websites or applications are stored in the keyboard memory device or processing memory device. The user accesses this password list by entering a single master password. The user can then view a list of stored passwords on the embedded keyboard display and scroll though the list using the up and down arrow keys. The user selects a password by pressing “Enter” when the password is selected. When the passwords are stored on the keyboard memory they are very difficult to hack or otherwise access without authority. According to further features in preferred embodiments of the invention, additional security measures, inter alia biometric components, are added to the input device.

In certain embodiments of the present invention, the keyboard uses onboard flash memory to store text in case of computer crashes. The added flash memory on the keyboard can be used by the computer operating system as additional storage space for storing files or for data caching—for the purpose of increasing the operating speed of the computer.

In certain embodiments of the present invention, the keyboard has a plurality of connection ports that allow multiple devices to be connected to the keyboard. Specifically, ports are provided for connecting flash memory drives and cellular phones to the keyboard. For mobile devices, such as phones or other communication devices, or data devices, a “male” USB connector is provided on the keyboard in order to charge the cell phone battery using the keyboard and to directly access the phone memory. This enables performing secure transactions over the connected phone or device through the use of secure passwords as provided hereinabove. This also enables using the keyboard to type directly into the mobile device, for example in order to send an SMS message or search for a contact entry. This feature is particularly useful for small mobile devices (e.g., phones and mp3 players) where text entry is difficult due to the size of the device keypad. Thus, the keyboard of the present invention controls multiple devices.

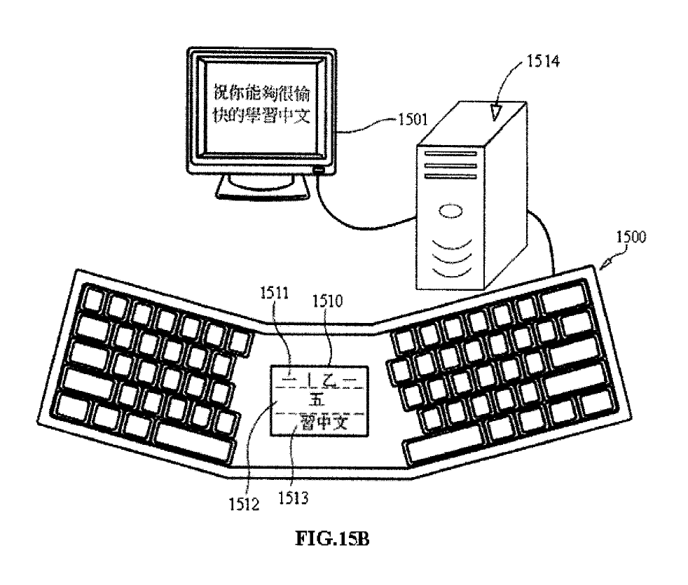

Reference is made to FIG. 14 showing a keyboard according to the teachings of the present invention. The keyboard is connected to PC 1414 and to mobile phone 1412. Data from PC 1414 is sent to respective primary display 1413. The keyboard includes USB slots 1410 and 1411. As mentioned above, in certain embodiments USB slot 1410 is replaced with a male USB connector that is preferably inserted into a corresponding USB slot on mobile phone 1412. This eliminates the need for the USB wire shown in FIG. 14.

Also shown in FIG. 14 are embedded display 1408 and dedicated function keys 1402 and 1404. Function key 1402 is used to switch the active keyboard language in a multilingual system. For example, in a system configured to support input in English and Greek, when the active language is English, pressing key 1402 switches the active language to Greek. A second press on key 1402 switches the active language back to English, Similarly, when more than two languages or input methods are supported, each successive key press of key 1402 advances the active language to a different language our input method. For example, in a system supporting English, Chinese Pinyin and Chinese stroke inputs, when the active input is English, pressing key 1402 switches the active input mode to Chinese Pinyin. A second press on key 1402 switches the active language to Chinese stroke input. A third press on key 1402 switches the active language back to English. The currently active language is shown in display section 1403 of embedded display 1408. In FIG. 14 display section 1403 is shown containing the letters GR indicating that the current active language is Greek.

Function key 1404 is used to switch the active connected device. For example, the keyboard is connected to PC 1414 and to mobile phone 1412, as shown in FIG. 14. When the active input device is PC 1414 all keyboard input is sent thereto and displayed on display 1413. A press on key 1404 switches the active device to mobile phone 1412. All keyboard input is now sent to mobile phone 1412. A subsequent press on key 1404 switches the active device back to PC 1414. As described above, when more than two devices are connected, each press on key 1404 switches the active device. The currently active device is shown in display section 1405 of embedded display 1408. In FIG. 14 display section 1405 is shown containing the term USB1 indicating that the current active device is mobile phone 1412 connected via USB slot 1410. USB slot 1411 is referred to in display section 1405 as USB2. When PC 1414 is the active device, display section 1405 contains the term PC.

Alternatively, instead of letters, display section 1405 displays an icon of the active device and display section 1403 displays an icon of the active language (such as a corresponding national flag) or active input method.

In some embodiments, display sections 1405 and 1403 are touch sensitive. Accordingly, touching these areas toggles the respective function (language or device) instead of keys 1402 and 1404.

In some embodiments, keys 1402 and 1404 include a dynamic display. Accordingly, the key surfaces indicate the currently active respective function (language or device) instead of display sections 1403 and 1405. For example, the upper surface of these keys include eInk displays that can be dynamically changed to display the active language or device.

For input devices designed to handle languages with multi-stroke characters, reference is now made to FIGS. 15A and 15B showing personal computer 1514 connected to both main display 1501 and keyboard 1500. At the center of keyboard 1500 is embedded display 1510. According to preferred embodiments of the invention, embedded display 1510 is logically divided into three sections. A first section 1513 shows text as it appears on the main display 1501 of personal computer 1514. This is text that has already been entered. The remaining two sections, 1512 and 1511, are used for entering new multi-stroke characters as described below.

Multi-stroke characters are typically entered through a sequence of keystrokes. For example, Stroke input methods provide several keys representing the basic stroke elements used to form a multi-stroke character. As the user enters a series of strokes, the keyboard driver generates a plurality of possible multi-stroke characters that comprise the entered stroke elements. At some point the user selects one of the plurality of generated characters as his intended character, or only one multi-stroke character is available that includes all of the strokes entered in the sequence.

As depicted in FIG. 15B, according to this method, section 1511 displays the sequence of keystrokes entered by the user for the current multi-stroke character. And section 1512 displays a plurality of possible multi-stroke characters that include the series of entered strokes. This is advantageous for several reasons. First, the sequence of entered strokes is clear to the user. Second, the stroke information need not be shown on the personal computer primary display, allowing the primary display to show only fully entered multi-stroke text. Third, by displaying a plurality of possible multi-stroke characters in section 1512 the system facilitates the user to select an intended character after a short series of keystrokes.

This selection can be made in several ways. One method is to provide a unique number next to each of the possible multi-stroke characters shown in section 1512. When the user presses a number key, the corresponding multi-stroke character is selected. Because the number of strokes is less than the number of alphabetic keys on the keyboard, alphabetic keys not used for strokes can be used instead of (or in addition to) number keys for this purpose. This is advantageous because the non-stroke alphabetic keys are closer to the stroke keys than the numeric keys and also allow the system to provide more than the 10 single keystroke options corresponding to the ten digits 0-9. Ideally, possible characters are displayed in section 1512 in their order of probability, e.g., based on frequency of usage in the general population, or usage patterns of the current user.

Moreover, the higher probability characters are associated with non-stroke alphabetic keys that are situated closer to the stroke keys; the lower probability characters are associated with non-stroke alphabetic keys (or numeric keys) that are situated distal to the stroke keys. This facilitates selecting the higher probability characters. A second method is to provide section 1512 with touchscreen functionality and allow the user to tap the intended multi-stroke character in order to select it.

Another example of a method for entering multi-stroke characters is called Pinyin. In Pinyin input methods the user enters a series of alphabetic keystrokes whose corresponding phonemes constitute the intended multi-stroke character. Here too, as the user enters a series of keystrokes, the keyboard driver generates a plurality of possible multi-stroke characters that comprise the phonetics of the entered letters. At some point the user selects one of the plurality of generated characters as his intended character, or only one multi-stroke character is available that includes all of the phonemes entered in the sequence.

As depicted in FIG. 15A, in this case, section 1511 shows the series of entered letters as an English transliteration of the phonemes and section 1512 displays a series of possible intended multi-stroke characters. For example, a single phoneme, “QING,” may indicate more than one character, such as for example “ [symbol] ” or “ [symbol] ”. The driver presents these multi-stroke characters in section 1512 and the letters QING in section 1511. The methods of selecting an intended one of the possible multi-stroke characters in section 1512 are the same as those described above regarding stroke input.

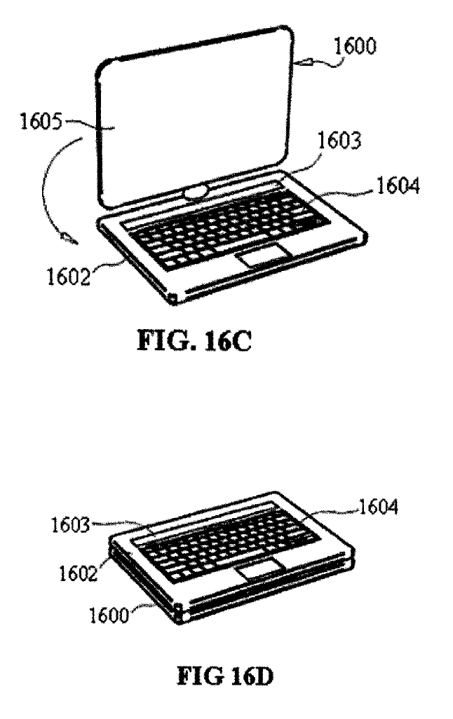

Reference is now made to FIG. 16 showing a laptop including a keyboard and embedded display. FIG. 16A shows an open laptop. The two halves of the laptop are section 1600 that includes display screen 1601, and section 1602 that includes keyboard 1604 and embedded display 1603. FIG. 16B shows how section 1600 is rotated so that its outer surface 1605 faces keyboard 1604, as depicted in FIG. 16C. Section 1600 is closed as indicated by the arrow in FIG. 16C, so that: (a) section 1600 is below keyboard section 1602; (b) keyboard 1604 and embedded display 1603 are exposed; and (c) display screen 1601 is covered and protected by section 1602. This closed position with exposed keyboard 1604 and embedded display 1603 is shown in FIG. 16D.

Alternatively, the hinge connecting sections 1600 and 1602 enables rotating section 1602 in a similar fashion to the rotation of 1600 depicted in FIG. 16B. Thus, beginning with the open laptop of FIG. 16A, wherein keyboard 1604 and embedded display 1603 face upwards, section 1602 is rotated so that keyboard 1604 and embedded display 1603 face down. Now, section 1600 is closed on top of section 1602. The closed laptop is now turned over so that exposed keyboard 1604 and embedded display 1603 face up. Thus, (a) keyboard 1604 and embedded display 1603 are exposed; and (b) display screen 1601 is covered and protected by section 1602. This closed position with exposed keyboard 1604 and embedded display 1603 is shown in FIG. 16D.

It will be appreciated by persons skilled in the art that the subject matter of the present invention can be implemented in various devices, including personal computers, laptop computers, television sets with keyboard input devices, mobile telephones, mobile data devices and the like. The definition of input device and/or “keyboard” is not limited to any specific input device, computer or other keyboard and particular layout or any number of keys, or keys functions. The various input devices contemplated by the present invention is not limited to such input devices having on-board keys, rather any input device which a user can interact with is also included. The present invention can be applied to various text or character input devices in various layouts and configurations. The on-keyboard display can be used on various devices where shifting of FoV by the user occurs, inter alia, with respect to screen devices with a wired or wireless connected keyboard, television sets, mobile devices associated with display screens, all in various shapes, sizes and configurations.

Having described the invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A computer system comprising:
(a) a primary display that displays a mouse pointer and multiple windows simultaneously, each window having text displayed therein, any window of which can be selectively activated at any given time;
(b) a keyboard comprising:
(i) an auxiliary display; and
(ii) input keys for editing text displayed on said primary and auxiliary displays;
(c) a processor connected to said primary display and said keyboard; and
(d) a non-volatile computer readable medium storing a computer program that programs the processor to enable a user to generate a single command to identify and capture at least a portion of the text displayed in the currently active window on the primary display and automatically display said captured text on said auxiliary display.

2. The computer system of claim 1, wherein said input keys are grouped into left and right groups of keys, and wherein said auxiliary display is situated between said groups.

3. The computer system of claim 1, wherein said input keys are grouped into upper and lower rows of keys, and wherein said auxiliary display is situated between said rows.

4. The computer system of claim 1, further comprising a mouse connected to said processor for controlling said mouse pointer, wherein said single command is initiated by at least one of:
(i) a mouse click;
(ii) a simultaneous mouse click and key depression;
(iii) a mouse-hover operation, or
(iv) a caret (text insertion point indicator, a.k.a. text cursor) position change.

5. The computer system of claim 1, wherein said computer program programs said processor to call at least one operating system function to:
(i) access an operating system object that includes text displayed near and around the mouse pointer or caret on said primary display; and
(ii) display at least a portion of said operating system object text on said auxiliary display.

6. The computer system of claim 5, wherein said computer program further programs said processor to:
(i) calculate a portion of said operating system object text that is displayed near said mouse pointer or caret on said primary display; and
(ii) display said calculated portion of text on said auxiliary display.

7. The computer system of claim 6, wherein said computer program further programs said processor to use attributes of a font of the operating system object text on the primary display in order to calculate the portion of the operating system object text that is displayed near said mouse pointer or caret on said primary display.

8. The computer system of claim 1, wherein said computer program includes a substitute screen render function that renders the currently active window on the primary display and provides a text value to said auxiliary display.

9. The computer system of claim 1, wherein said computer program programs said processor to:
(i) capture a bitmap of the currently active window on the primary display; and
(ii) perform character recognition on said bitmap.

10. The computer system of claim 9, wherein after the processor captures said bitmap, said computer program further programs said processor to:
(i) divide said bitmap into at least two sub-bitmaps: one to the left of said mouse pointer or caret, and one to the right of said mouse pointer or caret; and
(ii) perform character recognition on each sub-bitmap separately.

11. A computer system comprising:
(i) primary and secondary displays;
(ii) a keyboard in a housing, for inputting text that is displayed on said primary and secondary displays, wherein said secondary display is embedded in said keyboard housing;
(iii) a processor connected to said primary and secondary displays and to said keyboard; and
(iv) a non-volatile computer readable medium storing a computer program which instructs the processor to selectively direct input from said keyboard to at least one of the primary display and the secondary display.

12. The computer system of claim 11, wherein said primary and secondary displays display text in multiple languages, and wherein said secondary display indicates a current display language.

13. The computer system of claim 12, wherein said secondary display includes a touch-sensitive portion that displays an icon representing a display language, and wherein touching said touch-sensitive portion changes the display language.

14. The computer system of claim 11, wherein a plurality of key presses correspond to a single multi-stroke character; and wherein said computer program instructs said processor upon each successive key depression entered, to display, on said secondary display, a plurality of possible multi-stroke characters corresponding to the plurality of entered key depressions, and wherein said computer program further instructs said processor to enable a user to select one of said plurality of possible multi-stroke characters for display on said primary display.

15. The computer system of claim 14, wherein said secondary display is touch-sensitive, and wherein said computer program further instructs said processor to enable a user to select one of said plurality of possible multi-stroke characters by touching where it appears on said secondary display.

16. The computer system of claim 14, wherein said computer program further instructs said processor upon each successive key depression entered, to display, on said secondary display, English text corresponding to the plurality of entered key depressions.

17. The computer system of claim 14, wherein said computer program further instructs said processor upon each successive key depression entered, to display, on said secondary display, individual strokes corresponding to the plurality of entered key depressions.

18. A keyboard adapted for connection to a computer having a primary display, the keyboard comprising:
(i) a keyboard processor;
(ii) a secondary display connected to said keyboard processor;
(iii) a plurality of input keys connected to said keyboard processor; and
(iv) a computer readable medium storing a computer program which, when read by said keyboard processor, instructs the keyboard processor to direct input from said input keys to the computer or to said secondary display.

19. The keyboard of claim 18, wherein said computer readable medium further stores at least one password, and wherein said computer program instructs said keyboard processor to compare said password to data entered by a user before directing input from said input keys to the computer.

20. The keyboard of claim 19, adapted for connection to a plurality of computers simultaneously, further comprising a switch connected to said keyboard processor for selecting one of the plurality of computers to receive input from the keyboard, and wherein said switch is activated by the keyboard processor in response to input from said input keys.
